(19) United States
(12) Patent Application Publication
(10) Pub. No.: US 2023/0164888 A1
(43) Pub. Date: May 25, 2023

(54) COATED GLAZING

(71) Applicant: CARLEX GLASS AMERICA, LLC, Nashville, TN (US)

(72) Inventors: Michael Bard, Wadern (DE); Steven Scott CHRISTMAN, Nashville, TN (US)

(21) Appl. No.: 17/917,714

(22) PCT Filed: Apr. 9, 2021
(86) PCT No.: PCT/US2021/026605

§ 371 Date: Oct. 7, 2022

Related U.S. Application Data
(60) Provisional application No. 63/007,752, filed on Apr. 9, 2020.

(51) Int. Cl. H05B 3/86

(52) U.S. Cl. CPC H05B 3/86; H05B 2203/013; H05B 2203/031; H05B 2203/037; H05B 3/12

(57) ABSTRACT

A coated glazing useful for vehicles includes a first glass substrate and a heatable coating formed on the first glass substrate, the heatable coating including a partial deletion having a thickness thinner than a non-deleted portion of the heatable coating. The partial deletion of the heatable coating is formed in a differential heating area for variably heating the first glass substrate for deicing wiper park areas or any other heating desirable areas.

### CROSS REFERENCE TO RELATED APPLICATION

This application claims priority to U.S. Provisional Application No. 63/007,752 filed on Apr. 9, 2020, entitled “Coated Glazing” the entire contents of which are incorporated by reference herein in their entirety.

### TECHNICAL FIELD

The present disclosure generally relates to a glazing having a heatable coating with differential heating regions.

### DESCRIPTION OF RELATED ART

Glazings, including those which may be used in a vehicle, may include a heatable coating thereon. A heatable coating may be used, for example, to defrost a glazing, including an area where a wiper sits against a windshield. In a vehicle, heatable coatings may be used on any suitable glazing, such as a windshield, rear window, sunroof, or side window. In some glazings, it may be preferable to provide a localized area of increased heating. For example, it may be preferable to heat an area of a windshield adjacent to a wiper more than other parts of the glazing. Increasing heat around such a wiper park area may allow for deicing around the wiper to allow the wiper to function. As a further example, it may be preferable to heat an area of a windshield through which an information acquisition system such as a camera or sensor collects information from outside of a vehicle. Increasing heat around such a camera opening area may allow for defogging where fogging may interfere with the collection of clear information.

### SUMMARY OF THE DISCLOSURE

Disclosed herein is a glazing including a first glass substrate and a heatable coating formed on the first glass substrate, the heatable coating including at least one heatable layer and including at least one area of partial deletion wherein the heatable coating has a thickness thinner at the partial deletion than in a non-deleted portion of the heatable coating, wherein the partial deletion of the heatable layer is formed in a differential heating area of the heatable coating.

In an embodiment of the present disclosure, the heatable coating may include a single heatable layer and the partial deletion may include a partial thickness reduction of the single heatable layer. In another embodiment, the heatable coating may include first and second heatable layers. The partial deletion may include a total or partial thickness reduction of at least one of the first and second heatable layer. The heatable layers may contain silver or a transparent conductive oxide (TCO). A dielectric layer may be provided between first and second heatable layers.

In some embodiments, the glazing may further include a second glass substrate laminated to the first glass substrate. The heatable coating may be positioned between the first glass substrate and the second glass substrate. The differential heating area may be an area for a wiper to rest upon the glazing when installed in a vehicle. The glazing may include an opaque print area in the differential heating area.

In another aspect of the present disclosure, a method of providing a glazing with a heatable coating, may include the steps of: providing a first glass substrate formed with a heatable coating thereon; and removing at least a portion of at least one heatable layer in the heatable coating to provide a partial deletion in a differential heating area for variably heating the first glass substrate, wherein at least a portion of at least one heatable layer remains in the partial deletion.

In an embodiment of the present disclosure, the portion of the heatable layer may be removed by application of a laser to the coating or by physical abrasion of the coating. The heatable coating may include a single heatable layer where the partial deletion may include a partial thickness reduction of the single heatable layer.

In another embodiment, the heatable coating may include first and second heatable layers. The partial deletion may be formed from a total or partial thickness reduction of at least one of the first and second heatable layers. The heatable coating may include a blocking layer between the first and second heatable layers. Physical abrasion of the coating may include application of a grinding wheel, wherein the grinding wheel has a lower hardness than the blocking layer. The method may further include the step of laminating the first glass substrate with a second glass substrate. The method may include a step of forming an opaque print on the first glass substrate.

In a further aspect of the present disclosure, a laminated glazing may include a first glass sheet having surfaces S1 and S2, wherein S1 faces an exterior when installed and a second glass sheet having surfaces S3 and S4, wherein S4 faces an interior when installed, an interlayer provided between the first and second glass sheets, a heatable coating formed on either of the first and second glass sheets, the heatable coating including a first heatable region and a second heatable region having a higher heating capability than that of the first heatable region; a busbar supplying power to the heatable coating, and an opaque print formed on at least one of the first and second glass sheets, the opaque print hiding the busbar and the second heatable region when viewed from an exterior side of the first glass sheet.

In an embodiment of the present disclosure, the heatable layer may include at least one heatable layer including a partial deletion wherein the heatable layer has a thickness thinner at the partial deletion than in a non-deleted portion of the heatable layer and wherein the partial deletion of the heatable layer is formed in the second heatable region. In a further embodiment, the opaque print may be formed at least provided on the surface S2, and the busbar and the heatable coating may be formed on the surface S3. In another embodiment, the opaque print may be at least provided on the surface S2, and the busbar and the heatable coating may be formed on the surface S2. In such an embodiment, the busbar and the heatable coating may be formed on the opaque print, or the opaque print may be formed on the heatable coating.

In another embodiment, the second heatable region may be arranged at a wiper park area. In some embodiments, the heatable coating may be removed to from a camera opening area, and the second heatable region may be formed at a peripheral area of the camera opening area. The heatable layer may contain silver or may contain a transparent conductive oxide (TCO).

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a plan view showing a glazing, according to an embodiment of the disclosure;

FIG. 2 is a plan view showing a glazing, according to an embodiment of the disclosure;

FIG. 3 is a cross section showing a glazing with a differential heating region, according to an embodiment of the disclosure;

FIG. 4 is a cross section showing a glazing with a differential heating region, according to an embodiment of the disclosure;

FIG. 5 is a cross section showing a glazing with a differential heating region, according to an embodiment of the disclosure;

FIG. 6 is a cross section showing a glass sheets for a laminated glazing, according to an embodiment of the disclosure;

FIG. 7 is a cross section showing a laminated glazing, according to an embodiment of the disclosure;

FIG. 8 is a cross section showing a laminated glazing, according to an embodiment of the disclosure;

FIG. 9 is a plan view showing a glazing, according to an embodiment of the disclosure; and

FIG. 10 is a plan view showing a glazing, according to another embodiment of the disclosure.

### DETAILED DESCRIPTION

In the following description, for purposes of explanation, specific details are set forth in order to promote a thorough understanding of one or more aspects of the disclosure. It may be evident in some or all instances, however, that many aspects described below can be practiced without adopting the specific design details described below.

Where a heatable coating is functional across an entire windshield, areas of differential heating may be formed with deleted regions separating the coating into electrically isolated portions with separate busbars for each isolated coating area. However, it may be preferable to minimize the number of busbars and electrical connections required. For example, it may be preferable to provide a heatable glazing having two busbars and differential heating across the glazing without requiring electrically isolated portions. In this specification, the terms of “top,” and “bottom” designate edges of the glazing respectively when installed in a vehicle.

Heatable coatings may include one or more heatable layers and may include dielectric layers between heatable layers where there is more than one heatable layer in the coating. In some embodiments of the present disclosure, a heatable coating may include a single heatable layer subject to thickness reduction. In another embodiment, a heatable coating may include a layer stack having at least two heatable layers where at least one heatable layer may be removed or reduced in thickness. The heatable layers may be electrically connectable and heated when powered by a power source. A heatable coating may include a metallic coating, such as an infrared reflective coating. The metallic layers may preferably be silver containing layers. The silver containing layer may have a silver content of 90 mass % or more. In particular embodiments described herein, the metallic coating may include at least two metallic layers as the heatable layers, which may be separated by dielectric layers. Example heatable coatings may comprise a sequence of layers as follows: dielectric layer/silver/dielectric layer or dielectric layer/silver/dielectric layer/silver/dielectric layer. The dielectric layers may comprise metal oxides, nitrides or oxynitrides, for example, tin oxide, zinc oxide, silicon nitride, titanium oxide, aluminum oxide or mixtures of one or more thereof. In certain embodiments, a heatable coating may include a transparent conductive oxide (TCO) coating, such as a Low-E coating. A TCO coating may include at least one TCO layer, such as Indium Tin Oxide (ITO) layer(s), as the heatable layers, which may be separated by dielectric layers. The thickness of a metallic layer may be from 1 nm to 100 nm, preferably 5 nm to 50 nm, more preferably 8 nm to 30 nm. The thickness of a dielectric layer may be 1 nm to 100 nm, preferably 5 nm to 50 nm, more preferably 8 nm to 30 nm. The thickness of a TCO layer may be from 1 nm to 200 nm, preferably 10 nm to 150 nm, more preferably 20 nm to 100 nm. The heatable coating, having any suitable heatable layers, may be provided in a laminated glazing. Preferably, the heatable coating may be on a glass surface within the laminated glazing. The visible light transparency of the glazing or the laminated glazing may be 70% or more, preferably 72% or more, to satisfy regulatory requirements. Visible light transparency may particularly be determined by ISO 3538:1997, “Road vehicles—Safety glazing materials—Test methods for optical properties.” To measure light transmission across a wavelength spectrum or at a particular wavelength, any suitable equipment complying with the ISO standard may be used, such as a UV-Vis Spectrophotometer (e.g., U4000, Hitachi High-Tech Science).

A laminated glazing may include a first glass substrate and a second glass substrate laminated together with an interlayer material therebetween. The thickness of the glass substrates is not particularly limited, but is preferably from 0.5 mm to 3.0 mm. The glass substrates may include, without limitation, soda-lime silicate glass described by ISO 16293-1:2008. In some embodiments, the first glass substrate may be an exterior glass substrate facing a vehicle exterior when the glazing is installed, and the second substrate may be an interior glass substrate facing a vehicle interior when the glazing is installed. Alternatively, the first glass substrate may be an interior glass substrate and the second glass substrate may be an exterior glass substrate, depending on the manufacturing process.

Particularly, an interlayer may be a polymer adhesive, such as polyvinyl butyral (PVB), ethylene vinyl acetate (EVA) or an ionomer. A heatable coating may be formed on a glass substrate prior to lamination. In the laminated glazing, the heatable coating may be protected from corrosion from exposure to external elements. In some embodiments, the coating may be deleted around an edge of the glass substrate. The heatable coating may be connected to a power source via busbars formed on the coating. Preferably, the coating includes two busbars formed opposite each other, such that electrical current may pass across the coating between the busbars. The busbars may be made, for example, by printing a conductive paste on a coating formed on a glass substrate, in particular by the screen-printing method, which may be fired, for example, during bending of the glass substrate. The busbars may, for example, be implemented as strip-shaped or band-shaped electrodes. The busbars may include a thin, narrow metal foil strip of copper or aluminum, for instance, that include a conductive adhesive layer, applied with electrical contact to the heatable coating. The adhesive foil strip may be attached over a conductive paste material formed on the heatable coating.

Where it is preferable to variably heat the coating, such as for a wiper park area, the coating according to the present disclosure may include partial deletions. The partial deletions, or partially removed areas of the heatable layer(s), may locally increase resistance in the coating such that the amount of heat generated by ohmic resistance heating increases to enable faster deicing and/or defogging. The electric current may be locally forced through narrow and/or long stretches due to the partial deletions which may locally increase the electrical resistance. The increased resistance may cause the coating to locally heat more than areas of the coating with no partial deletions. The partial deletions may be in the uppermost layer of the heatable coating and the partial deletion may be made by application of laser abrasion or any other means of physical deletion from an exposed surface of the heatable coating on the workpiece, such as by the use of physical abrasion. The partial deletions may be formed in any suitable shape, such as straight, zigzag, or curved lines. For example without limitation, partial deletion may be formed with multiple deleted lines of 0.1 mm width with intervals of 0.5 mm. Shape, width, length, and/or interval may be varied depending on a purpose/location of heating. The partial deletions may be produced as lines perpendicular to a substrate edge or hatching lines, or also from parallel or random patterns.

The area of a coating having partial deletions may be any suitable shape and size. In some embodiments, an area having partial deletions may extend across all or part of a bottom portion of a glazing. The area having partial deletions may include multiple areas of deleted coating. For example, a vehicle may include two wipers positioned on a windshield and a windshield coating may preferably heat areas of the windshield corresponding to each wiper position. Through application of a supplied voltage on the two busbars, the heatable coating areas with partial deletions and without partial deletions may be heated simultaneously. The coating area with partial deletions may heat more than the coating area without partial deletions. For example, the heatable coating area without partial deletions may be configured such that with impingement by an on-board voltage of 12 to 48 V, a specific heating output of 3 to 6 watts/dm² is obtained and the heatable coating area with partial deletions may be configured such that with impingement by an onboard voltage of 12 to 48V, a specific heating output of 5 to 20 watts/dm² is obtained. Deletions may be controlled by width, length, and depth. By controlling depth and relative positioning of the deletions, one area of partial deletions, or an area of differential heating, may have a local variation in resistance. Where a differential heating area desirably has a gradually changing heat profile, such deletion control may be used to provide a gradual differential heating area.

It may be preferable, in some embodiments, for a glazing to include a heatable coating having multiple conductive layers. For example, a coating may include two or three conductive metallic or TCO layers. The partial deletions may preferably not extend through all of the conductive layers. Thus, a full or partial conductive layer of the heatable coating may remain intact even where there are partial deletions extending partially through the coating. Where there are three conductive layers, there may remain one or two conductive layers without deletions. Where the deletions would be formed through the entire coating, the portion of the coating at the deletion would have no heatable materials. According to the present disclosure, the coating maintains a heatable material across the entire coated area. Thus, there may not be an interruption in heating. The coating may be entirely deleted in some areas, which are not part of the coated area, including around a periphery of a glazing substrate or in an area for a sensor or camera. By preventing the interruption in heating, heat may be relatively more evenly distributed across the area of the coating having partial deletions. Further, the design of the partial deletions may be flexible. For example, the partial deletions may be wider, compared to a full deletion, as the coating retains conductivity across the entire coating area.

In some embodiments, the partial deletions may be formed using a laser. The laser may be absorbed by the coating and locally decompose said coating without affecting the underlying material. The laser may be configured to locally vaporize a part of the coating. For the present description, the laser may be focused, with a suitable shape and size, on some coating layers without deleting the lower coating layers. Particularly, a laser may be configured such that the laser strength deletes at least one or part of a heatable layer of the coating without deleting the entire coating such that at least part of a heatable layer remains intact at the partial deletion. The preferable power and/or focus of a laser may be determined based on the coating materials and the number and thickness of layers to be deleted by the laser.

Laser power sources known in the art for laser deletion for an automotive glazing for electric sensor installation may be used. For example, equipment producing a pulsed green laser with a wavelength of 532 nm and frequency of 10 kHz may be used. In some embodiments, a continuous or pulsed infrared laser with a wavelength of 1059-1065 nm may be used. Moreover, power, pulsation and/or frequency may be periodically or non-periodically varied or scanned. Variation of laser focus during scanning with or without a Galvano scanner may be also used. For another example, laser processing technology with spatial phase modulator or holographic optics may be used. The laser processing may include interfering laser beams to create the partial deletion. Interfering lasers may provide a stable, energy efficient system over a focused laser beam. An axicon lens may be used to create the deleted openings described herein with interfering laser beams. Further, the interfering beams may be focused on the coating such that openings may be reliably formed on a three-dimensionally bent glass substrate.

In some further embodiments, a partial deletion may be formed by physical abrasion. For example, a grinding wheel may be applied to the coating to provide partial deletions through part of the coating. Where a coating includes at least two heatable layers, a blocking layer may be provided between the heatable layers. Preferably, a blocking layer may be harder than an abrasion tool, such as a grinding wheel. Where the blocking layer is harder than such a grinding wheel, the wheel may be used to remove layers of the coating above the blocking layer. The blocking layer may include, without limitation, oxide, nitride or oxynitride of silicon (Si), titanium (Ti), aluminum (Al), zirconium (Zr) or tungsten (W), or combinations thereof, depending on a hardness of the desired physical abrasion tool. The heatable layer positioned below the blocking layer may remain intact, protected by the blocking layer and partial deletions may be formed in the heatable layer of the coating above the blocking layer.

For various uses, including for automotive glazings, glass substrates may be thermally treated, including bending and/or tempering. Where the heatable coating is applied to a glass substrate prior to thermal treatment, the partial deletions may be formed before or after the thermal treatment.

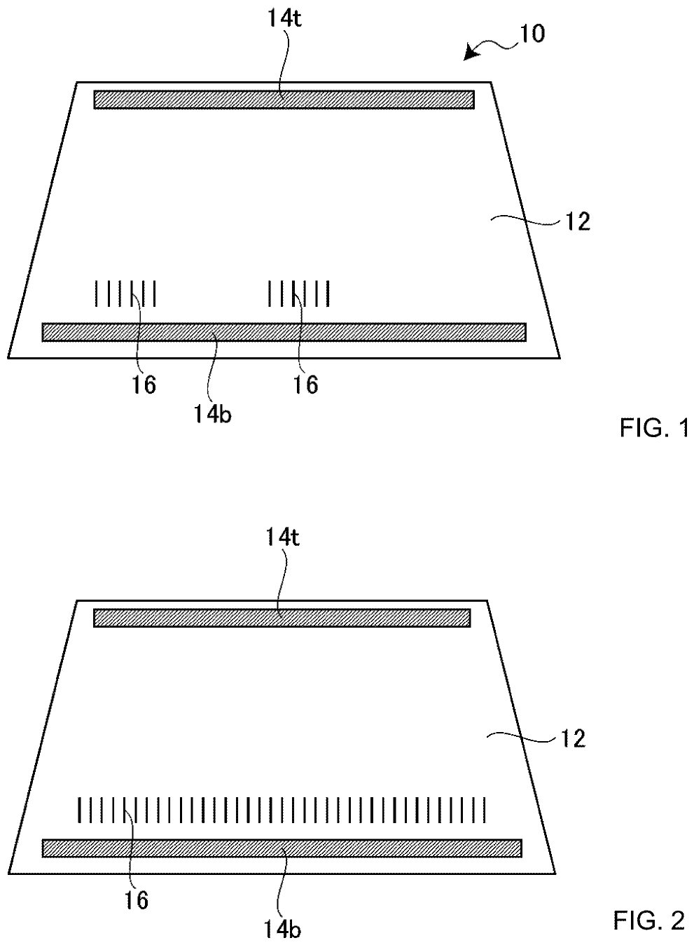

FIG. 1 illustrates a glazing 10 having a heatable coating 12 thereon. The glazing 10 is suitable for a windshield of a vehicle and is shaped in a trapezoid form with curving edges, not shown for simple illustration purpose, to fit the frame of the vehicle. The heatable coating 12 may be formed on the entire surface of the glass substrate, but the periphery of the heatable coating 12 may be removed in order to prevent the deterioration of the edge of the heatable coating. Busbars 14b, 14t may be positioned opposite each other on the heatable coating 12 so as to provide power to the coating 12. In some embodiments the busbars may be positioned on left and right sides of the coating as shown in FIG. 10 rather than the top and bottom of the coating as shown in. FIG. 1. Partial deletions 16 are shown formed in the heatable coating 12 in wiper park areas. The partial deletions 16, as shown, may be provided in more than one area on the glazing. Partial deletions 16 may be formed in areas of the heatable coating 12 where increased heating is desired, including wiper park areas, sensor areas, or camera areas at which cameras are positioned to collect information through the glazing 10.

FIG. 2 illustrates another embodiment of the glazing 10 having a different pattern of the partial deletions 16. In this embodiment, the partial deletions 16 are formed extending along the bottom edge of the glazing and covering wiper park areas.

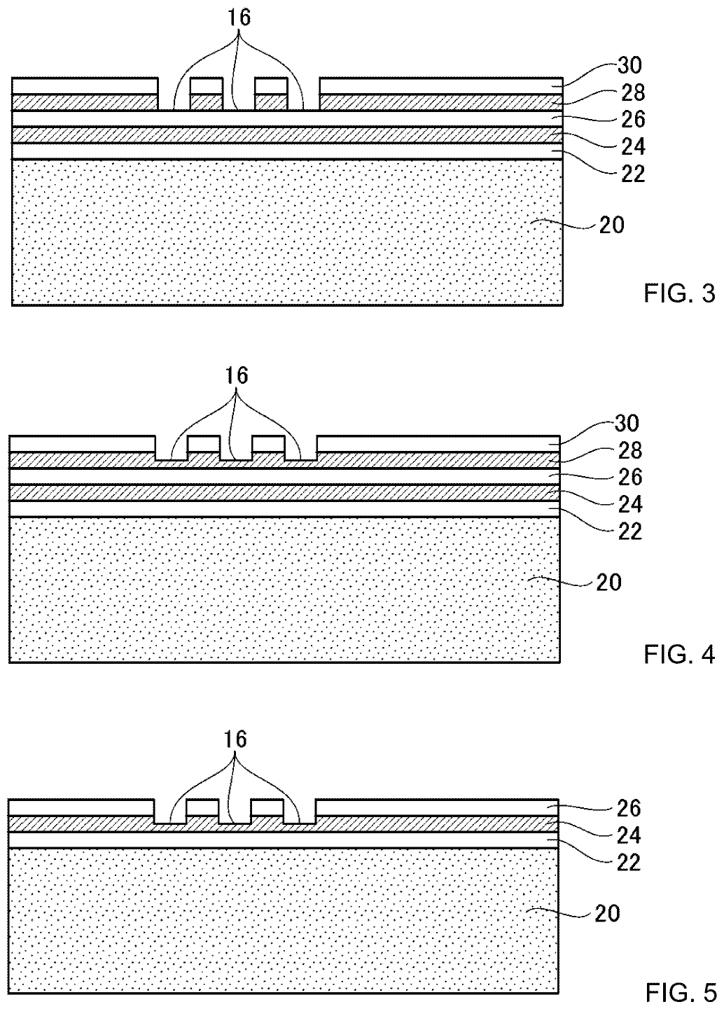

FIG. 3 to FIG. 5 show variations of partial deletions 16. FIG. 3 shows the partial deletions 16 having a totally deleted thickness of a heatable layer 28. In FIG. 3, a multilayer heatable coating having five layers, namely, a dielectric layer 22, a first heatable layer 24, a dielectric layer 26, a second heatable layer 28, and a dielectric layer 30, is formed on a first glass substrate 20. As described above, the first and second heatable layers 24, 28 may be formed of silver containing layers or any other transparent metal or conductive oxide layers. The dielectric layers 22, 26, 30 may be formed of a material containing metal oxides, nitrides, oxynitrides and the like as main components. The heatable layers 24, 28 and the dielectric layers 22, 26, 30 may be, for example, coated on the glass substrate 20 by a sputtering method. The glazing shown in FIG. 3 has partial deletions 16 formed by deleting a portion of the dielectric layer 30 and the second heatable layer 28. The dielectric layer 30 and the second heatable layer 28 are removed entirely within the partial deletions 16, thereby exposing the dielectric layer 26. The partial. deletions 16 can be in any shape and in any proximity to each other so as to locally increase the electric resistance in the area of the partial deletions, between the two busbars. An example configuration may include partial deletions 16 arranged as a series of straight, parallel strips. Where physical abrasion is used to prepare partial deletions 16 as shown in FIG. 3, the dielectric layer 26 may serve as a blocking layer for stopping physical abrasion.

FIG. 4 shows another type of the glazing 10. In the embodiment shown in FIG. 4, a multilayer heatable coating may be formed on the first glass substrate 20 with the same five layers 22, 24, 26, 28, 30 as those of the glazing shown in FIG. 3. At the partial deletions 16, the entire thickness of dielectric layer 30 is removed while a partial thickness of the second heatable layer 28 is removed. The partial deletions 16 may be in any shape or proximity to each other so as to locally increase the electric resistance and may be arranged, for example, as a series of straight, parallel strips. According to the structure shown in FIG. 4, the second heatable layer 28 may be removed up to a midway point of the thickness of the second heatable layer 28 during the deletion process. One advantage of this structure is to ensure the current flow through the partly deleted second heatable layer 28, so that the second heatable layer 28 can generate heat across the partial deletions 16.

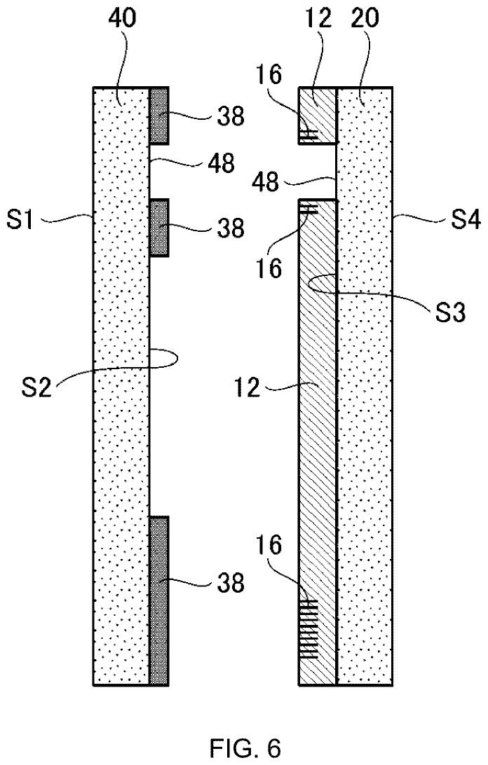

FIG. 5 illustrates yet another example of the glazing 10. In this embodiment, the multilayer heatable coating having three layers: a dielectric layer 22, a first heatable layer 24, and a dielectric layer 26 is formed on the first glass substrate 20. At the partial deletions 16, the entire thickness of the dielectric layer 26 is removed while a partial thickness of the first heatable layer 24 is removed. The partial deletions 16 may be in any shape or proximity to each other so as to locally increase the electric resistance and may be arranged as a series of straight, parallel strips. With this structure, the first heatable layer 24 is removed up to a midway of the thickness during the deletion process. This structure may ensure the current flow across the heatable coating, even across the partial deletions 16.

Where the glazing is a laminated glazing such as a windshield, the first glass substrate may be laminated with a second glass and an interlayer therebetween. Preferably, the heatable coating may be positioned between the first and second glass substrates in such a laminated construction. FIG. 6 shows a schematic cross section of glass substrates for use in a laminated glazing, including an exterior glass substrate 40 and an interior glass substrate 20. In FIG. 6, the exterior glass substrate 40 has opaque prints 38 and the interior glass substrate 20 has the heatable coating 12 having the partial deletions 16. The exterior glass substrate 40, serving as a first glass sheet, is provided on an exterior side of the windshield, when installed in a vehicle, with an exterior surface S1 and an inner surface S2. The interior glass substrate 20, serving as a second glass sheet, is provided on an interior side of the windshield, when installed in a vehicle, with an inner surface S3 and an interior surface S4 facing the vehicle interior. A black print, or namely an opaque print 38 is formed on the inner surface S2 of the exterior glass substrate 40. The opaque print 38 may be any suitable material, including a black enamel frit, and may be provided on any suitable surface, including a glass substrate surface or a laminated film surface. Particularly, the printing may be provided around a windshield peripheral area including the wiper park areas and a peripheral area of a camera opening area 48. The opaque print 38 may not be formed in the camera opening area. The heatable coating 12 may be completely deleted in the camera opening area so as not to disturb the information collected from outside of a vehicle by the camera. The opaque print 38 may further align with the wiper park areas and may block an exterior view of the partial deletions 16 in the heatable coating 12. A dot pattern area of the opaque print 38 may be formed at an edge of the opaque print 38 at the windshield peripheral. area. Opaque prints may be further provided on the interior surface S4.

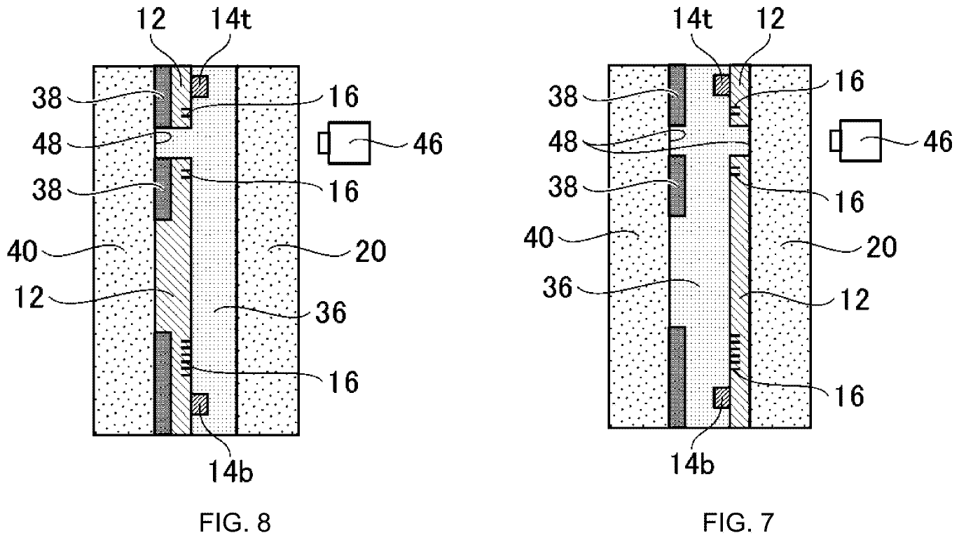

The exterior glass substrate 40 and the interior glass substrate 20 may be laminated as shown in FIG. 7 with an interlayer 36 which may include, e.g., polyvinyl butyral (PVB), ethylene vinyl acetate (EVA), or an ionomer. The partial deletions 16 may be formed in the heatable coating 12 on inner surface S3. The heatable coating 12 may have a multilayer structure as described above, and the partial deletions 16 may be formed in any type shown in FIG. 3 to FIG. 5, or combinations thereof A combination may include, for example, a heatable coating 12 having two or three heatable layers wherein one heatable layer may be fully deleted and another heatable layer may be partially deleted within the partial deletions 16. A heatable coating 12 may include, for example, one, two, or three heatable layers. The partial deletions 16 may create a differential heating area for variably heating the exterior glass substrate 40. Positions of the partial deletions 16 are designed to correspond to the areas at which differential, or varied, heating application is desirable, such as, e.g., a peripheral area of the windshield, near the wiper park, a peripheral area of a camera opening area, and any other areas that increased heating application is suitable. The opaque print 38 may be useful for hiding the busbars 14b, 14t and the partial deletions 16 of the heatable coating 12 when viewed from an exterior side of the exterior glass substrate 40. Other opaque prints may be provided on the interior surface S4. A camera 46 or other information acquisition system like a sensor or a radar may be arranged near the top of the laminated glazing to collect the information from outside of a vehicle through a camera opening area 48 formed within the opaque print 38. The partial deletions 16 may be formed to provide heat to the peripheral area of the camera opening 48.

FIG. 8 shows another laminated glazing having a similar structure. The laminated glazing has an exterior glass substrate 40 and an interior glass substrate 20, and an interlayer 36 sandwiched by the exterior glass substrate 40 and the interior glass substrate 20. In FIG. 8, the opaque prints 38, the partial deletions 16, and the busbars 14 are provided on inner surface S2 of the exterior glass substrate 40. Other opaque prints may be provided on the interior surface S4. The opaque prints 38 may be formed on the heatable coating 12, though the heatable coating 12 is formed over the opaque prints 38 in FIG. 8.

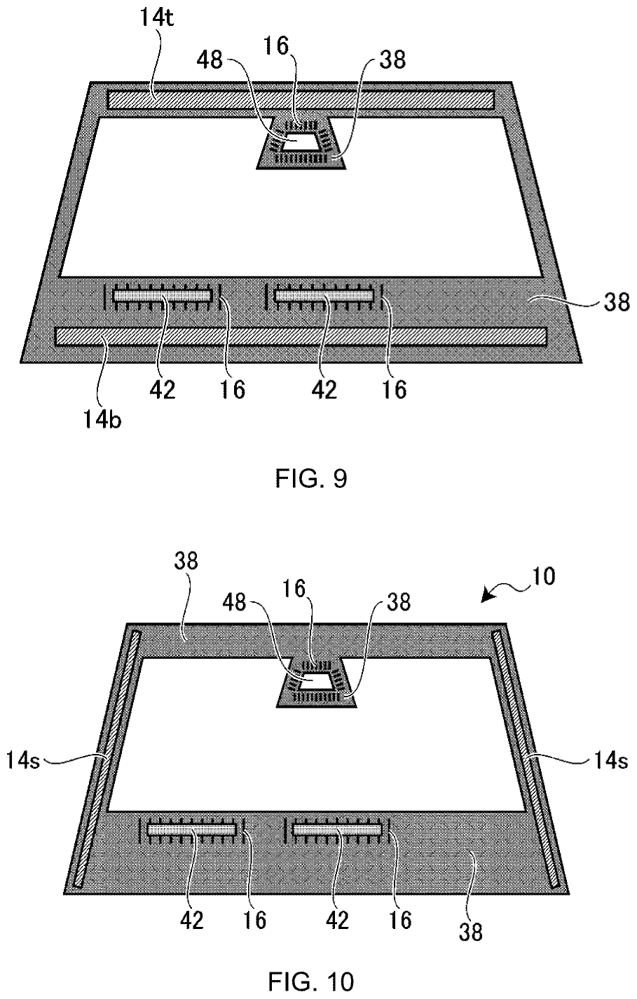

FIG. 9 and FIG. 10 show example embodiments of glazings disclosed herein. FIG. 9 illustrates a glazing having busbars 14t, 14b on the top and bottom of the glass structure. FIG. 10 shows the busbars 14s arranged on side edges of the laminated glazing behind the opaque print 38. A pair of wipers 42 are shown in FIG. 9 and FIG. 10 at wiper park areas having partial deletions 16 where the wipers may sit when installed in a vehicle. The partial deletions 16 may provide differential heating in the area, locally heating the heatable coating more than in areas without deletions. On the top side of the laminated glazing, the partial deletions 16 are arranged along a camera opening area 48 to provide heat to deice or defog the camera opening area 48. With this layout, the power is supplied via the busbars 14t, 14b, 14s, thereby generating heat across the windshield with areas of higher heating in the differential heating areas having partial deletions 16. The location of a pair of wipers 42 where they may sit when installed in a vehicle are shown to align with the differential heating area having partial deletions 16. In addition, the partial deletions 16 are shown around the camera opening area 48 to provide heat to the camera opening area 48.

Producing the glazing thus formed with a heatable coating may include the following steps. First, a first glass substrate may be prepared with a heatable coating thereon.

After forming a heatable coating, at least a portion of at least one heatable layer in the heatable coating is removed to form a partial deletion in the heatable coating. The removal may be achieved by using a laser abrasion or a physical abrasion process.

The opaque print may be formed on a first or second glass substrate. If the opaque print is made on the first glass substrate, the opaque print may be made before or after the formation of the heatable coating.

After forming the partial deletions and opaque print, an interlayer film may be arranged between the first and second glass substrates, which may then be deaired and autoclaved to provide a laminated glazing with the heatable coating having the differential heating area.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glazing, comprising:
a first glass substrate, and
a heatable coating formed on the first glass substrate, the heatable coating including at least one heatable layer and including at least one partial deletion wherein the heatable coating has a thickness thinner at the partial deletion than in a non-deleted portion of the heatable coating,
wherein the partial deletion of the heatable layer is formed in a differential heating area of the heatable coating.

2. The glazing according to claim 1, wherein the heatable coating includes a single heatable layer and the partial deletion includes a partial thickness reduction of the single heatable layer.

3. The glazing according to claim 1, wherein the heatable coating includes first and second heatable layers.

4. The glazing according to claim 3, wherein the at least one partial deletion includes a total thickness reduction of one of the first and second heatable layers.

5. The glazing according to claim 3, wherein the partial deletion includes a partial thickness reduction of one of the first and second heatable layers.

6. The glazing according to claim 1, wherein the heatable layer contains silver.

7. (canceled)

8. (canceled)

9. The glazing according to claim 1, further comprising a second glass substrate laminated to the first glass substrate.

10. (canceled)

11. The glazing according to claim 1, wherein the differential heating area is an area for a wiper to rest upon the glazing when installed in a vehicle.

12. (canceled)

13. A method of providing a glazing with a heatable coating, comprising the steps of:
providing a first glass substrate formed with a heatable coating thereon; and
removing at least a portion of at least one heatable layer in the heatable coating to provide a partial deletion in a differential heating area for variably heating the first glass substrate, wherein at least a portion of at least one heatable layer remains in the partial deletion.

14. The method according to claim 13, wherein removing the portion of the at least one heatable layer comprises applying a laser to the heatable coating.

15. The method according to claim 13, wherein removing the portion of the at least one heatable layer comprises physical abrasion of the heatable coating.

16. The method according to claim 13, wherein the heatable coating includes a single heatable layer wherein the partial deletion includes a partial thickness reduction of the single heatable layer.

17. The method according to claim 13, wherein the heatable coating includes first and second heatable layers.

18. The method according to claim 17, wherein the partial deletion includes a total thickness reduction of one of the first and second heatable layers.

19. The method according to claim 17, wherein the partial deletion includes a partial thickness reduction of one of the first and second heatable layers.

20. The method according to claim 18, wherein the heatable coating includes a blocking layer between the first and second heatable layers.

21. (canceled)

22. The method according to claim 13, further comprising a step of laminating the first glass substrate with a second glass substrate.

23. (canceled)

24. (canceled)

25. A laminated glazing, comprising:
a first glass sheet having surfaces S1 and S2, wherein S1 faces an exterior when installed and a second glass sheet having surfaces S3 and S4, wherein S4 faces an interior when installed;
an interlayer provided between the first and second glass sheets;
a heatable coating formed on either of the first and second glass sheets, the heatable coating including a first heatable region and a second heatable region having a higher heating capability than that of the first heatable region;
a busbar supplying power to the heatable coating; and
an opaque print formed on at least one of the first and second glass sheets, the opaque print hiding the busbar and the second heatable region when viewed from an exterior side of the first glass sheet.

26. The laminated glazing according to claim 25, wherein the heatable coating includes at least one heatable layer including a partial deletion, wherein the heatable layer has a thickness thinner at the partial deletion than in a non-deleted portion of the heatable layer, and wherein the partial deletion of the heatable layer is formed in the second heatable region.

27. (canceled)

28. (canceled)

29. (canceled)

30. (canceled)

31. (canceled)

32. (canceled)

33. The laminated glazing according to claim 25, wherein the heatable layer contains silver.

34. (canceled)
